(19) United States
(12) Patent Application Publication
(10) Pub. No.: US 2013/0220566 A1
(43) Pub. Date: Aug. 29, 2013

(54) DRAWN ENDLESS CLOTHING

(71) Applicant: Voith Patent GmbH, (US)

(72) Inventors: Michael Straub, Steinheim (DE); Robert Eberhardt, Ellwangen (DE)

(73) Assignee: Voith Patent GmbH, Heidenheim (DE)

(21) Appl. No.: 13/853,581

(22) Filed: Mar. 29, 2013

Related U.S. Application Data
(63) Continuation of application No. PCT/EP2011/067555, filed on Oct. 7, 2011.

(30) Foreign Application Priority Data
Oct. 27, 2010 (DE) 10 2010 049 490.9
Dec. 22, 2010 (DE) 10 2010 063 870.6

(51) Int. Cl. D21F 1/80; B29C 55/00

(52) U.S. Cl. CPC D21F 1/80; B29C 55/00
USPC 162/289; 156/229

(57) ABSTRACT

A fabric for papermaking machines is produced from a belt-shaped film substrate which consists essentially of a non-oriented polymer. The film substrate is bent in such a way that the two end edges of the film substrate adjoin one another. Subsequently, the two adjacent end edges are joined to one another in a material-to-material manner. The endless film substrate which is formed in this way is finally stretched in the circulating direction of the endless film substrate which is formed in this way.

### CROSS REFERENCE TO RELATED APPLICATIONS

This is a continuation of PCT application No. PCT/EP2011/067555, entitled “STRETCHED ENDLESS FABRIC”, filed Oct. 7, 2011, which is incorporated herein by reference.

### BACKGROUND OF THE INVENTION

1. Field of the Invention

The present invention relates to clothing for papermaking machinery and, in particular to clothing for the support and transport of a fibrous web in paper machines.

2. Description of the Related Art

The generic term of “paper” is to be understood to include papers of various types, carton and cardboard. As a rule, the production of paper starts with the formation of a fibrous web from a fibrous suspension. Clothing is used in paper machines as a support for the suspension and the still not yet self-supporting fibrous web. As a rule, clothing is in the embodiment of endless belts which, rerouted over rollers, circulate within a certain section of the paper machine. In forming the fiber or fibrous web, a fibrous suspension placed onto clothing in the forming section of a paper machine is dewatered through the clothing. The clothing, generally referred to as forming fabric, is equipped with passages in this region through which water is withdrawn from the fibrous suspension or respectively from the fibrous web being formed on the clothing. In downstream sections of a paper machine felts are used which are generally applied onto a mechanically high load bearing water-permeably carrier clothing. High performance water-permeable clothing is also used in the drying section.

Clothing, or respectively carrier clothing, currently used in paper machines consist predominantly of woven material. Woven clothing features uniform structures with a repeat basic pattern. Woven clothing is generally composed of several woven layers having different thread sizes and thread directions. Because of their different weave structures, the individual layers of such clothing not only have a water permeability differing from each other but—since the openings or passages in the top layers regularly are covered by threads of woven layers beneath them—also lead laterally to local variations in permeability of the woven clothing (top layer is hereby to be understood to be the paper side layer of the clothing, in other words the woven layer on which the fibrous suspension or respectively the fibrous web is supported). A laterally varying permeability results in a laterally varying dewatering velocity of the fibrous web, which in turn leads to visible markings in the paper web and thereby to a poor paper quality, whereby the differently dewatered regions are present in a uniform arrangement due to the uniform repeat in the weaving pattern. Lesser dewatered regions in a web may moreover have a lower fiber density.

Woven types of clothing have a lesser flexural strength and therefore are often prone to crease formation during rotation through the machine. The use of monofilaments of various materials, for example a combination of yarns consisting of polyethylene terephthalate (PET) and polyamide (PA) on the running side of a clothing opposite the paper side layer moreover leads to protruding or curling of side edges, due to the different characteristics of these materials in regard to water absorption, expansion, etc.

Many types of clothing cannot be woven as an endless belt. To form an endless belt, both ends of a continuously long woven belt must be connected with each other. In order to avoid irregularities at the connecting location which would lead to markings in the paper web, the connection is currently made through a complicated woven seam structure, extending over a larger area. The expensive manufacture of woven forming fabrics associated with this is reflected in accordingly high production costs.

As an alternative to woven clothing, types of clothing were suggested which are produced from nonwoven material webs. In patent specification CA 1 230 511 and U.S. Pat. No. 4,541,895 an example of a clothing is cited which is formed from a laminate of several layers of nonwoven, water-impermeable materials into which openings are introduced for the purpose of dewatering. However, to produce such film laminates in the dimensions necessary for paper machines is very expensive. Such multilayer film laminates are moreover very stiff and have a tendency to delaminate under the conditions prevailing during use in the forming or drying section of a paper machine.

In U.S. Patent Application Publication No. 2010/0230064 clothing for use in paper machines is cited, which is produced from a spirally wound polymer belt. The width of the polymer belt is considerably narrower than the width of the clothing produced therefrom, whereby the longitudinal direction of the polymer belt—except for the slanting provided by the winding height—is consistent with the direction of travel of the clothing. The side edges located opposite each other of adjoining winding cycles of the polymer belt are welded together to form a closed running surface.

Clothing is subjected to very high tensile stresses in paper machines, leading to stretching of the polymer belt. In order to counter this, the polymer belt used in the manufacture of the clothing is normally drawn, whereby the drawing can occur in one, in another, or in both directions, depending upon a particular application. Polymer belts used in the production of clothing in the winding process described above are normally drawn at least in the longitudinal direction. The polymer orientation and crystallinity obtained through drawing are impaired at the welded seams, whereby the mechanical stability of the clothing is weakened at these locations. In order for this not to lead to deformation of the clothing during rotation, the slant of the welded seam relative to the direction of rotation of the clothing must be sufficiently small, so that the tensile stresses are completely absorbed by the polymer belt and cannot lead to stretching of the welded seam. In relationship of length to width of the clothing the polymer belt must hereby be relatively narrow, thereby resulting in a very long welded seam. To create the welded seam the pre-wound polymer belt must either be guided below the laser beam, or the laser beam must be directed over the pre-wound polymer belt. Both methods are technologically very expensive, thereby resulting in high production costs.

What is needed in the art is a clothing for paper machines which is formed from a film-like endless substrate which possesses uniform mechanical characteristics across the surface of the substrate.

### SUMMARY OF THE INVENTION

The present invention provides clothing manufactured from an endless film substrate which is produced according to one of the following methods. A starting point for the manufacturing process is a belt-like film substrate consisting of a polymer. The polymer is, for example, non-oriented or only slightly drawn. The film substrate is bent so that the two end edges of the film substrate adjoin one another. Subsequently, the adjoining end edges are joined in a material-to-material manner. The thus produced endless film substrate is finally drawn in a direction which is essentially consistent with the direction of rotation. The material-to-material joined end edges of the endless film substrate are arranged, for example, transversely or diagonally to the direction of rotation of the endless film substrate, whereby transverse is to be understood to be an angle of approximately 90 degrees and diagonal is to be understood to be an angle of between approximately 40 and 90 degrees relative to the direction of rotation of the endless film substrate. A diagonal progression of the seam, that is a diagonal progression of the material-to-material joined end edges, for example has the advantage during drawing that only one section of the seam is subjected to the respective drawing stress at any one time.

In this document, the term film substrate is to be understood to refer to a body whose thickness is considerably less than its lateral dimensions.

Additional embodiments of the method also include a step whereby the two end edges of the film substrate are provided with a compatible profiling prior to the material-to-material connection. In certain arrangements of the method, the profiling of the end edges is in the form of a bevel, step profile, step profile with beveled butt edges, tongue and groove profile or combinations thereof.

It is pointed out that terms such as “comprise”, feature”, “include”, “contain” and “with” as well as their grammatical deviations used in this description and in the claims in order to list characteristics generally indicate a non-exhaustive listing of characteristics, for example of process steps, features, regions, dimensions and similar, and in no way exclude the existence of additional and other features or groupings of other or additional features.

Additional embodiments of the method can also include steps to use light with a wave length which is not absorbed by the film substrate for the material-to-material connection of the two end edges of the film substrate, and steps for coating of at least one of the two end edges with an absorption material which absorbs light of the employed wavelength.

In further embodiments of the method the stretch force used to draw the endless film substrate is kept constant during one rotation of the endless film substrate, whereby the length of one rotation can be greater than the circumferential length of the endless film substrate. According to the method of the present invention, the drawing, for example, occurs in one rotation.

Additional embodiments of the method include a step for heat-setting of the drawn endless film substrate.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic illustration of clothing in the embodiment of an endless belt;

FIG. 2 is a welded seam connection of the endless belt of FIG. 1 according to a first embodiment;

FIG. 3 is a welded seam connection of the endless belt of FIG. 1 according to a second embodiment;

FIG. 4 is a welded seam connection of the endless belt of FIG. 1 according to a third embodiment;

FIG. 5 is a welded seam connection of the endless belt of FIG. 1 according to a fourth embodiment; and

FIG. 6 is a schematic illustration of a device for drawing an endless belt such as the one illustrated in FIG. 1.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

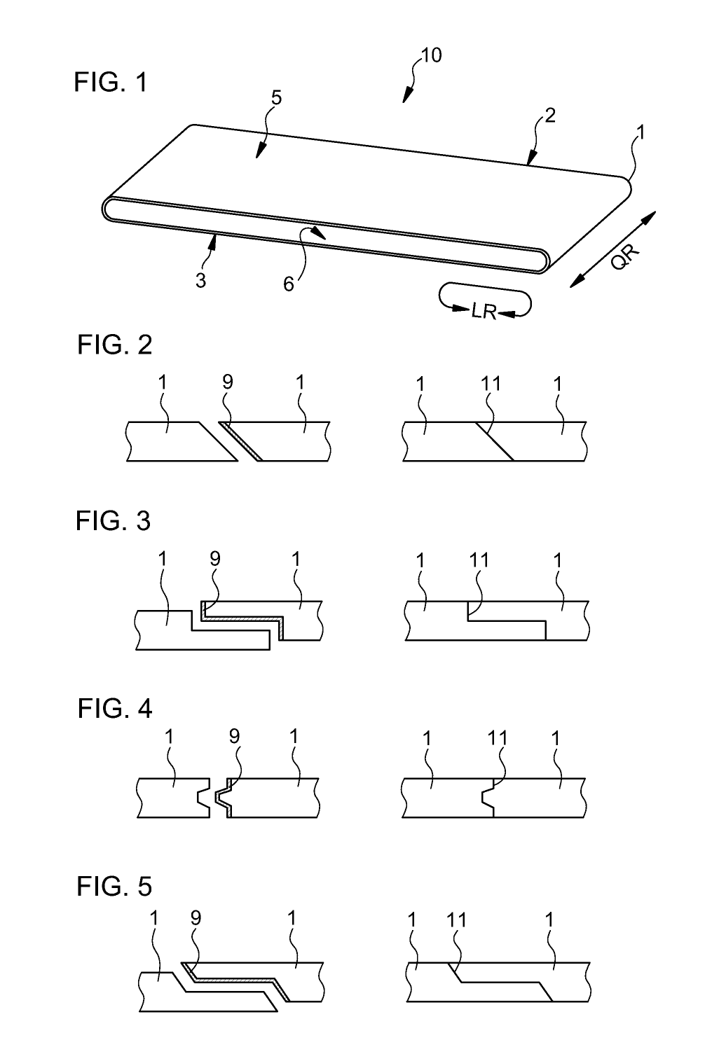

Referring now to the drawings, and more particularly to FIG. 1, there is shown a schematic depiction of clothing 10 in the embodiment of an endless belt. The clothing consists of belt-like film substrate 1 which is defined on its sides by side edges 2 and 3, each of which follows a continuous line, and therefore has no end. Accordingly, the belt is also continuous in the embodiment of a so-called endless film substrate. In the illustrated embodiment the edges are oriented in a direction of rotation or respectively circumferential direction LR of clothing 10. Besides side edges 2 and 3, belt 1 is defined by two surfaces 5 and 6 arranged opposite each other. Machine side 6 of the belt, shown in the illustration facing itself, represents the inside surface of the clothing and as a rule, is used to transfer forces for rotation of the belt. Outward facing surface 5, the paper-side surface located opposite the machine side surface in FIG. 1 normally serves as a support for the fibrous suspension or respectively the fibrous web. When the clothing is used as a support clothing, the outside surface serves the application of additional clothing components.

Direction QR provided by the width expansion of belt 1 is referred to as the cross direction in the following description and when using the clothing in a paper machine is consistent with the cross machine direction. The rotation of clothing 10 occurs transversely thereto, in direction LR which is also referred to as the longitudinal direction or the direction of travel and whose spatial progression is illustrated in FIG. 1, which shows a sketch of the clothing.

To form porous clothing 10, for example for use as a forming or drying fabric, belt 1 may be equipped with a multitude of holes which are not illustrated in FIG. 1. Each of the holes forms a passage from outside surface 5 of belt-like endless film substrate 1 to inside surface 6. These holes are also referred to as pores and, depending on their location in the paper machine facilitate sheet formation by means of dewatering of a fibrous material supported on the clothing during production of paper, or serve further dewatering of the fibrous web.

To produce a mechanically stable clothing from polymeric film-like endless belt 1, a belt-like flat substrate produced through extruding or casting of thermoplastic synthetic materials such as, for example polyethylene terephthalate (PET), polyethylene naphthalate (PEN), polyphenylene sulfide (PPS), polyetheretherketone (PEEK), polyamide (PA) and poly-olefins is, for example, used. These materials are known in the form of sheets or in rolls and are commercially available. Since the thickness of the flat substrate is considerably less than its lateral dimensions it is also referred to as film substrate or respectively film-like substrate in this document. The characteristic of the substrate described as belt-like refers to its configuration having a defined width and as a rule a length which is independent therefrom.

The film substrates used to form the inventive clothing are preferably not drawn. Since with limited draw factors no significant change in the polymer structure occurs, lightly drawn film substrates may be used in place of non-oriented film substrates. To produce clothing 10 the two edges arranged transversely or diagonally to the direction of travel of the clothing, the so-called end edges or respectively ends of the film substrate are joined with each other in a material-to-material manner. The material-to-material connection occurs, for example, through welding of the two end edges, whereby welding processes such as ultrasound welding, thermal welding or transmission welding may be utilized. Unevenness occurring during welding, for example burrs or melted edges are leveled after welding in order to obtain a homogeneous belt surface. Leveling occurs through grinding or smoothing, for example with ultrasound or through mechanical removal of protrusions, for example through material removing processes, for example milling or grinding. The end edges of the film substrate are, for example, arranged to abut each other and are then welded together, whereby the end edges may feature complimentary profiles facing each other, in order to create larger connecting surfaces and to possibly enable improved alignment of the edges with each other. The film substrate ends may alternatively be overlapped and welded together and subsequently leveled.

If the film substrate material does not possess sufficient absorption for the form of energy used for welding then an absorption material can be applied onto one (as illustrated) or both (not illustrated) of the two interface layers of the film substrate, as illustrated in FIGS. 2, 3, 4 and 5. If using a transmission welding process in the NIR range (NIR: near infrared), light having wavelengths in the range of approximately 700 to 1400 nanometers (nm) and sufficient intensity is directed onto absorption layer 9. Since the energy input into the substrate material which is transparent for the wavelengths used is in itself very low, a targeted heat introduction into the surfaces adjoining the absorption layers is achieved. Consequently, only the interfaces of the two abutting end edges of the film substrate are fused, so that they can be adjoined dimensionally stable through simultaneously pressing them together. The contact pressure may for example be applied by means of a roll which is transparent for the utilized light wave lengths and which is directed over the seam location to be welded and which is being penetrated by the light used for welding. Light sources suitable for transmission welding are NIR-radiators and in particular lasers, for example diode lasers having emission wavelengths in the range of 808 to 980 nm and neodymium-doped: yttrium aluminum garnet (Nd:YAG) lasers having an emission wavelength of 1064 nm.

Alternatively, absorber-free welding processes, for example laser welding processes with wavelengths in the range of approximately 1700 to 2000 nm may also be used, whereby the laser beam is focused, for example, onto the end edges which are to be welded together. Another alternative is the use of a second laser or an additional intensive light source whose wavelength is effectively absorbed by the web material and which preheats the film substrate material in the region of the end edges, whereby the simultaneously or subsequently irradiated welding laser absorbs better and can thereby be utilized more effectively.

Enlarging of the connecting area and a precisely fitting welding can be achieved through beveling or other formed profiling of the butt edges. Examples for accordingly processed film substrate edges are illustrated in FIGS. 2, 3, 4 and 5 respectively in non-joined (left) and joined (right) state. FIG. 2 illustrates a side view of the two opposite ends of film substrate 1. Absorber layer 9 which is potentially applied on one of the end edges is shown crosshatched in FIGS. 2, 3, 4 and 5. After welding, the two end edges are bonded with each other on connecting surface 11.

In contrast to the beveled embodiment according to FIG. 2, the two belt ends or respectively end edges of the example illustrated in FIG. 3 feature a mutually complimentary step profiling. Here too, absorber layer 9 can be used on the mating surface for better connection of the ends. An additional example of a joint edge profile is shown in FIG. 4. In this embodiment, the edges of film substrate 1 to be joined are prepared in the form of a complimentary tongue and groove profile, whereby the tongue and groove are configured with a slight taper in order to enable effortless joining of the end edges. This profile shape distinguishes itself in particular through great security relative to an unintended vertical offset of the two belt ends during the joining process. As in the prior examples, absorber layer 9 can also be applied in this case onto one or both end edges of the film substrate, in order to facilitate joining of the film substrate ends by means of welding. FIG. 5 illustrates a departure from the complimentary step profile illustrated in FIG. 3 which is characterized by beveled butt edges.

The inventors have found that the polymer structure of the welded seam of a cast or extruded thermoplastic film substrate to a large extent resembles that of the untreated film substrate. The welded seam therefore exhibits approximately the same characteristics as does the rest of the film substrate. This has been confirmed by tests in which the material-to-material “seams” run problem free through the drawing process described below, in other words do not exhibit stretching deviating significantly from the stretching of the remaining film substrate.

Following the manufacture of the endless film substrate it is then drawn into endless belt 1. This drawing occurs, for example, non-directionally in longitudinal direction LR of the endless film substrate, that is in direction of travel of same, alternatively bi-directionally in longitudinal or cross direction QR. The device used for drawing is equipped with at least one heating zone and at least one drawing roller unit. Heating of the specific region of the endless film substrate which is at any given time located in the heating zone occurs, for example, through hot air or infrared radiators. In order to achieve sufficiently high strength of endless belt 1, the film is stretched during drawing in direction of travel LR by means of one or several drawing roller units by a factor in the range of approximately 2 to 10, for example by a factor in the range of 3 to 6. The belt not only becomes longer as a result of this, but also thinner. In order to obtain drawn belts with a defined desired length, the starting length of the endless film substrate must be less than the stretch factor:

L_{F}+L_{EB}/SF_{LR};

whereby L_{F} indicates the starting length of the endless film substrate (in direction of travel or respectively drawing direction) and L_{EB} indicates the length of endless belt 1 after drawing of the endless film substrate by the drawing factor SF_{LR} in longitudinal direction. The drawing factor SF is hereby selected in such a way that during intended use of the clothing in a paper machine no significant elongation of the clothing occurs. A possible drawing in cross direction QR with a stretch factor SF_{QR}, for example in the range of 2 to 3 is subsequently carried out.

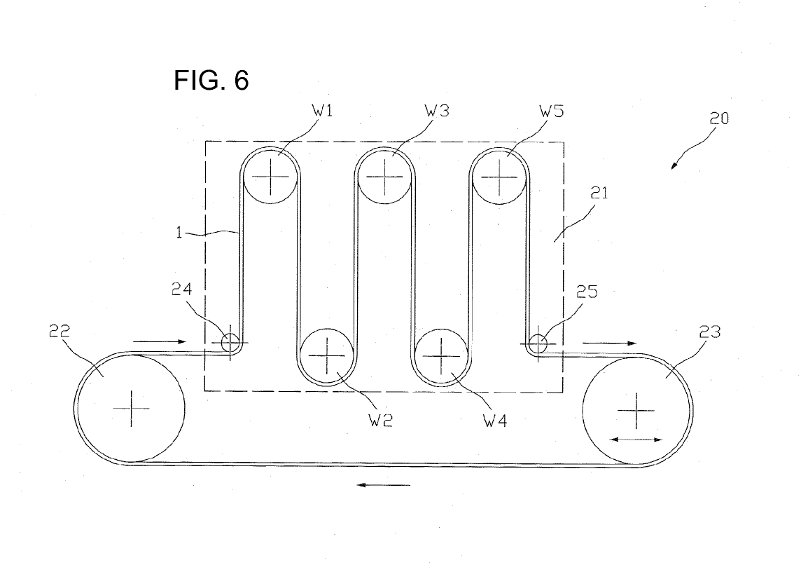

FIG. 6 illustrates one possible embodiment for device 20 for drawing a previously described endless film substrate 1. The drawing device includes stretching unit 21 and a device for compensating the belt elongation during the drawing process, consisting of stationary roll 22 and movable roll 23. The displacement can be realized by means of tensioning roller 23 on a cantilevered support. The direction of displacement of tensioning roller 23 is indicated by the double arrow; it can be linear, but can also be pivoted. The actual drawing of endless film substrate 1 occurs in stretching unit 21, where endless film substrate 1 is guided over several draw rollers, for example five draw rollers W1 to W5. The stretching unit is heated in the area of the draw rollers. The speed of rotation of at least two consecutively located draw rollers relative to guidance of the endless film substrate is hereby different, whereby the speed of rotation of the downstream draw roller viewed in the direction of travel of the endless belt is higher than that of the preceding one. In device 20 illustrated in FIG. 6, stretching can occur in two segments, for example between draw rollers W2 and W3, as well as W4 and W5. In this case the following applies for the speeds of rotation v(Wx) of the draw rollers in the direction of travel of endless film substrate 1 indicated by arrows: v(W2)<v(W3) and v(W4)<v(W5). Rolls 24 and 26 merely serve to redirect the endless film substrate from the device for compensating of the belt length to the draw rollers.

Drawing begins at a discretionary location of the endless film substrate. Drawing occurs, for example, in one or several drawing steps during one rotation of the endless film substrate. In this case the drawing process must not be terminated prior to the location at which it began, so that no non-oriented regions remain. The stretching force for each draw roller pair is kept constant during a rotation. Since an already drawn section does not experience noticeable changes when running again through the stretching unit under unmodified drawing conditions, a rotational distance can be selected for drawing which is longer than the circumference of the endless film substrate. Drawing may also occur in several rotational cycles, however the stretching force must then be increased from one rotation to the next. Whether the stretching process occurs in one or in several rotational cycles depends on the thereby achieved mechanical characteristics of the drawn film substrate. As a rule, when using polyethylene terephthalate as the material for the endless film substrate, stretching is, for example, to occur essentially during one rotation.

In order to produce porous clothing 10, film substrates including imperfections are used in certain embodiments. For the formation of imperfections, calcium carbonate particles may, for example, be incorporated during extrusion of the film substrates. Tensions occurring at these imperfections during drawing of the film substrates result in tearing of the polymer material in the vicinity of the imperfections, thereby forming small openings, penetrating through clothing 10. The porosity of clothing 10 can be controlled through the number and/or size of the particles.

In order for clothing 10 not to shrink during its intended use in the paper machine, which would mean a reduction in rotational length and possibly width of clothing 10 caused by thermal influence, the clothing is heat set after drawing. For purposes of heat setting, the endless film substrate is subjected to a final heat treatment which, for example, occurs through use of the heating zone of the drawing unit and simultaneously keeping the belt length of the film substrate constant. The stretched endless film substrate, for example, runs through the drawing unit with constant speed until its heating zone has reached the necessary target temperature for heat setting. After one rotation at the target temperature, the temperature of the heat zone is reduced, for example through turning off the heat source. The endless film substrate is moreover kept in rotation until it is cooled down. The temperature necessary for heat setting is between the glass transition temperature and the softening temperature of the respective material. In the case of polyethylene terephthalate temperatures in the range of 150 to 220° C. may be utilized.

The width of the drawn endless belt 1 is, for example, in the range of approximately 1 to 10 meters. If the width of an endless film substrate drawn in accordance with one of the above methods is less than the width of the endless belt to be produced, then two or more drawn endless film substrates of the same length and the same level of stretch in cross direction can be arranged side by side and can be welded together in the direction of travel. For welding one of the previously described transmission welding processes may be used, whereby side edges of the endless film substrates which are to be welded together can be profiled complimentary relative to each other, for example by utilizing one of the profile shapes illustrated in FIGS. 2 through 5. Embodiments of clothing produced according to one of the previously described inventive methods have a thickness in the range of approximately 150 to 800 micrometers (μm).

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for producing a clothing for a paper machine, the method comprising the steps of:
providing a belt-like film substrate comprising a polymer;
bending said film substrate such that two end edges of said film substrate adjoin one another;
joining said two end edges of said film substrate in a material-to-material connection to form an endless film substrate; and
drawing said endless film substrate in a direction of rotation of said endless film substrate.

2. The method according to claim 1, wherein said material-to-material joined end edges are arranged transversely to said direction of rotation.

3. The method according to claim 1, wherein said material-to-material joined end edges are arranged at an angle in the range of between 40 and 90 degrees relative to said direction of rotation of said endless film substrate.

4. The method according to claim 1, further comprising the step of providing said two end edges of said film substrate with mutually complimentary profiling prior to said material-to-material connection.

5. The method according to claim 4, wherein said profiling is in the form of at least one of a bevel, a step profile, a step profile with a plurality of beveled butt edges, and a tongue and groove profile.

6. The method according to claim 1, further comprising the step of using a light with a wavelength which is not absorbed by said film substrate for said material-to-material connection of said two end edges of said film substrate, at least one of said two end edges being coated with an absorption material which absorbs said light of said wavelength.

7. The method according to claim 1, said drawing step further comprising the step of keeping a stretch force used to draw said endless film substrate constant during one rotation of said endless film substrate, wherein a length of said one rotation is greater than a circumferential length of said endless film substrate.

8. The method according to claim 7, wherein said drawing step occurs in one rotation of said endless film substrate.

9. The method according to claim 8, further comprising the step of heat setting the drawn endless film substrate.

10. A method of producing a porous clothing for a paper machine, the method comprising the steps of:
providing a polymer including a plurality of particles of a material different to said polymer incorporated into said polymer to form a polymer-particle compound;
extruding said polymer-particle compound into a belt-like film substrate;
bending said film substrate so two end edges of said film substrate adjoin one another;
forming an endless film substrate by material-to-material connection of said two end edges; and
drawing said endless film substrate in a direction of rotation of said endless film substrate.

11. The method according to claim 10, wherein said material-to-material joined end edges are arranged transversely to said direction of rotation.

12. The method according to claim 10, wherein said material-to-material joined end edges are arranged at an angle in the range of between 40 and 90 degrees relative to said direction of rotation of said endless film substrate.

13. The method according to claim 10, further comprising the step of providing said two end edges of said film substrate with mutually complimentary profiling prior to said material-to-material connection.

14. The method according to claim 13, wherein said profiling is in the form of at least one of a bevel, a step profile, a step profile with a plurality of beveled butt edges, and a tongue and groove profile.

15. The method according to claim 10, further comprising the step of using a light with a wavelength which is not absorbed by said film substrate for said material-to-material connection of said two end edges of said film substrate, at least one of said two end edges being coated with an absorption material which absorbs said light of said wavelength.

16. The method according to claim 10, said drawing step further comprising the step of keeping a stretch force used to draw said endless film substrate constant during one rotation of said endless film substrate, wherein a length of said one rotation is greater than a circumferential length of said endless film substrate.

17. The method according to claim 16, wherein said drawing step occurs in one rotation of said endless film substrate.

18. The method according to claim 10, further comprising the step of heat setting the drawn endless film substrate.

19. A clothing for a paper machine, the clothing comprising:
a belt-like film substrate formed of a polymer configured such that two end edges of said belt-like film substrate are joined in a material-to-material connection to form an endless film substrate, said endless film substrate having been drawn in a direction of rotation of said endless film substrate.

20. A porous clothing for a paper machine, the clothing comprising:
a belt-like film substrate formed of a polymer and a plurality of particles of a material different than said polymer, said belt-like film substrate having been bent such that two end edges of said belt-like film substrate adjoin one another and joined in a material-to-material connection to form an endless film substrate which is drawn in a direction of rotation of said endless film substrate.
